(19) United States
(12) Patent Application Publication
(10) Pub. No.: US 2003/0200876 A1
(43) Pub. Date: Oct. 30, 2003

(54) Method and apparatus for continuous thermal processing of packaged products

(75) Inventors: Charley Brokaw, Reno, NV (US); James E. Wilson, Westerville, OH (US); Tom Manley, Columbus, OH (US)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA

(21) Appl. No.: 10/131,733

(22) Filed: Apr. 24, 2002

(51) Int. Cl. A23B 4/08

(52) U.S. Cl. 99/516

(57) ABSTRACT

A method and apparatus for continuously sterilizing and cooking packaged products. The packages are drawn through a hydrostatic-pressure cooker utilizing a cable-driven drive mechanism where clipped-packages are attached to the cable. As the package is maneuvered through the hydrostatic-pressure cooker heated water and steam may cook the contents of the package while sterilizing the exterior surface of the package. Batch sterilizing techniques are thereby avoided.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND OF THE INVENTION

1. Field of the Invention

The field of this invention relates generally to a method and system for sterilizing packaged products, and more particularly to a method and system for sterilizing packaged products in a hydrostatic pressure cooker utilizing a cable-driven conveyance mechanism.

2. General Background of the Invention

In the conventional process for sterilizing packaged foods, packages are first filled with a food product and sealed. Thereafter, the sealed containers are heated in a pressure cooker or retort to sterilize the packaged product. The packaged products are ordinarily placed on trays, cassettes, or bins and placed in the retort for a period of time. The retort not only sterilizes the product, but can be used to cook the product as well. The duration of the retort sterilization process is ordinarily determined based on the time required to heat up the retort, the trays, cassettes, or bins to the correct temperature and the “cold spot” of packages on the tray, cassette, or bin. In other words, the duration for the retort process is determined based on the length of time it would take to sterilize the package at the worst spot in the retort or sterilizer. The sterilization time is usually based on the center-most packages since these packages tend to heat up to the proper sterilization value after the outer-most packages on the tray, cassette, or bin. This is especially true where trays are stacked on one another, such that the inner packages take longer to heat up to the proper sterilization value. Each package is adequately sterilized, but packages on the outer periphery of the tray are overheated in relation to the center-most packages which leads to overcooking or uneven cooking of the contents of the packages.

A solution to the problem of long sterilization and uneven heating of packaged products, in particular canned products has been addressed in U.S. Pat. No. 5,301,603, to Mignogna et al. This patent describes a process and system for sterilizing packages of thermally-treatable products having different sterilization processing requirements. Generally disclosed is a chain-driven conveyance system for passing canned products through an optional pre-heat unit and then passing the products through a hydrostatic pressure cooker having towers for pre-heating, sterilizing, and cooling.

The tower-based hydrostatic sterilizer as disclosed in Mignogna and as conventionally used today for the sterilization and cooking of canned food products, however, requires significant capital costs not only in operation and maintenance, but the physical space necessary to operate such a sterilizer. The conventional hydrostatic sterilizer utilizes chain-driven trays or bins to move cans through the sterilizer. Utilizing these trays requires that the towers or legs be very wide to accommodate the trays. These towers have a height requirement to achieve proper pressures, for example height may be up to 60 to 80 feet tall.

Thus, it is desirable for an improved smaller hydrostatic sterilizer capable of sterilizing and cooking individual products. Moreover, it is desireable that such an improved hydrostatic sterilizer utilize a new conveyance mechanism to move individual packages through the sterilizer.

### SUMMARY OF THE INVENTION

The invention is directed to a method and system for sterilizing packaged products in a hydrostatic pressure sterilizer utilizing a conveyance mechanism for maneuvering packages through the hydrostatic pressure sterilizer. Among various aspects of the invention, one aspect is a continuous sterilization system, and another a pouch clip for package handling.

A continuous sterilization system provides a unique method of cooking products in soft packages. The system may also be modified to handle hard packages. The system attaches a package clip/gripping device to individual packages or a ribbon of packages, at or near a package filling unit. The package clips, holding the package, are attached to a cable which conveys the packages through a pressurized sterilizer. The sterilizer is in the form of a hydrostatic pressure cooker that may use either mechanical devices or hydrostatic water legs to maintain cooking pressures. A conventional hydrostatic sterilizer may be reduced in size and used with the invention herein. Additionally, a preheating unit may be used prior to conveying the packages through the sterilizer. Preheating the packages would reduce the overall time necessary through the sterilizer to achieve desired sterilization values.

One aspect of the invention is a process for sterilizing a packaged product. A package is first filled with a food product and then sealed to form an air tight seal. A package clip is attached to the package. The package via the package clip is then attached to a cable. The cable moves through a sterilizer, preferably a hydrostatic pressure cooker, thereby sterilizing the package. In addition to sterilizing the package, the food product contained in the package may be cooked by adjusting the time for which the package travels through the sterilizer.

Another aspect of the invention is a hydrostatic pressure cooker employing a cable-driven conveyance system for maneuvering packages through the hydrostatic pressure cooker. The traditional chain driven tray-based conveyance system is replaced with a cable-driven conveyance system. The hydrostatic pressure cooker has a cable which is moveable through the hydrostatic pressure cooker though the use of pulley's. Packages attached to the cable are moved through the various chambers of the pressure cooker.

The hydrostatic pressure cooker may be constructed of common pipe rather than a custom fabricated pressure chamber and may employ a unique configuration to increase the pressure of a pressure chamber while maintaining or even reducing the height of the towers of the pressure cooker. To provide for an increased pressure in the pressure chamber of the pressure cooker multiple water legs are connected in series. The pressure required for sterilization and/or cooking and the height desired for the device determines the number of water legs in the system. In a conventional hydrostatic pressure cooker using a single water leg, the water leg would be approximately 92 feet high in order to develop a 40 pound per square inch cooking environment. Using two water legs in series, the overall height of the water legs could be reduced to 46 feet high. Using three water legs is series the overall height of the water legs could be reduced to 31 feet high. After the water legs the size of the pressure cooking chamber would be determined by the desired cook time and the speed that product would be run through the pressure cooking chamber. After the pressure cooking chamber an equal number of water legs would be required to return the product to atmospheric conditions.

For a system using two water legs, the first water leg has, in sequence, an atmospheric chamber at atmospheric conditions and a fluid chamber for housing a fluid. The second water leg, in sequence, has a pressurized chamber at a pressure required to sustain the first water leg and a fluid chamber for housing a fluid. The pressurized chamber of the second water leg contains a pressurized gas, such as air. The fluid chamber of the second water leg is connected to the pressure leg. Due to the increased pressures from the first and second water legs a greater pressure may be achieved in the pressure cooker leg. The third water leg, in sequence, has a fluid chamber and a pressurized chamber. The fourth water leg, in sequence, has a fluid chamber and an atmospheric chamber at atmospheric conditions.

Another aspect of the invention is a manufacturing system for filling, packaging and sterilizing packages. After a food product is formed, a filler unit fills a package. After the package has been filled with the food product, the filling unit (or a separate unit) seals the package to form an air-tight seal. A clip loader then attaches a package clip to the package. A check weigher may be used to weigh the package. A cable loader then attaches the package clip to a cable. The cable is moveable through a sterilizer in a continuous fashion. The package attached to the cable is conveyed through the sterilizer. A cable unloader unit then removes the packages from the cable. An accumulator unit may be used to collect a number of packages.

Yet another aspect of the invention is a unique package clip for attaching a package to a cable or a rail. The package clip has a rail assembly and a clip assembly. The rail assembly is preferably shaped rectilinearly or with track grooves such that the rail assembly is moveable on a rail or a track. The rail assembly has a rail head with a slideable attachment arm positioned in the rail head. The slideable attachment arm is spring driven such that spring force maintains the attachment arm in a closed positioned. The package clip is attached to a cable by moving the attachment arm into an open position and placing a hook portion of the attachment arm around the cable. Tension from the spring will cause the hook to engage the cable. The rail head may include a longitudinal groove disposed along the length of the rail head to form a pocket into which the cable may be placed.

The clip assembly of the package clip has a hingedly attached gripping arm for attachment to a package. The gripping arm closes against another surface of the clip assembly to secure the package. The package clip in the shown embodiment are designed to handle pouched packaging, however, the package clip mechanism could be modified to handle any type of soft, or hard, packaging.

Among many benefits that are achieved by the present invention, some of these are: package clips are preferably attached to packages immediately after filling, so that the packages are positively held at all times; the package clips are easier to move and maneuver than individual packages, the package clips can be more easily staged than individual packages; surge or staging can be accomplished more economically prior to packaging for multi variety styles of secondary packaging; the total cost of clips is much less than cassettes or trays; the cost of the carrier cable is much less than the cost of conveyors for individual packages, there are fewer steps involved when handling the package clips, than there are with individual packages which reduces complexity; there are fewer parts to maintain which reduces maintenance costs; reliability of the system is improved due to the reduced complexity; the total system efficiency is greatly increased.

The prior art method of cooking, or sterilizing, pouches and soft packages, is to physically load them into trays or cassettes and then to load those into a batch retort. This requires either a great deal of equipment of a very large labor force. In contrast, the present invention provides a package clip and cable conveying system with a hydrostatic style of continuous sterilization. After a package is attached to the package clip and the package clip is attached to the cable, the package is simply conveyed through the sterilizer. Among many advantages, the present inventive type of continuous system over a batch system are as follows:

Continuous cooking uses about one forth the energy of batch cooking for two reasons. First, the energy goes into cooking the product rather heating up the trays or cassettes, the conveyors, and the retorts. Second, the system remains at cooking conditions as opposed to heating up and cooling down with every cycle;

In the continuous clip system the package is suspended in direct contact with the cooking steam, rather than surrounded by the stainless steel cassettes or trays;

Cooling has the same benefit as cooking; and

The cooker can be constructed out of common pipe so the initial cost is much less than a retort. The cooking pipe is simply a steam pipe with a cable conveying system inside. The length of the pipe and speed of the cable determines the cook time. The cooking pipe can also be arranged so that the pouches are transported from one area of the factory to another while they are being cooked.

The present invention is simpler than conventional hydrostatic cookers used for hard packaging. The present invention has the advantage of being able to use multiple water legs to increase the cooking pressure without increasing the overall height of the system. Since products packaged in soft containers, like pouches, must be over pressurized during the cooking and cooling steps, in order to maintain their integrity, this ability is critical. While it would be possible to construct a conventional style of hydrostatic sterilizer that could be used for soft packages, the cost of such a system would be prohibitive. As mentioned above the clip and cable cooker can be constructed of common pipe. Conventional hydrostatic sterilizers must be custom fabricated and require a great deal of structure to contain the internal cooking pressure. To build a conventional hydrostatic sterilizer capable of handling soft packages in an over pressure type of environment these structural requirements would go up substantially.

The conventional hydrostatic sterilizer uses chains with carriers, or flights, permanently attached to the chains, that the packaged product is loaded on to. These flights semi-contain the product as it is conveyed through the water legs and the cooking and cooling zones. The clip style of system uses the same clip that is used through out the process to convey the product through the water legs and the cooking and cooling zones. Since the package never changes from one carrier to the next there is much greater control of the package.

The cost of a continuous over pressure system can be reduced further using the multiple water leg concept. In any hydrostatic sterilizer the cooking pressure holds up a water leg which separates the cooking environment from ambient conditions. The product is conveyed up an empty leg and then down through this water leg and into the cooking area. The desired cooking pressure determines the height of the water leg in the system. For soft style packaging the pressure in the cooker must be approximately twice that of a system for hard packaging since the soft packaging is not able to withstand the internal pressure that develops during the cooking and cooling processes. In order to develop the over pressure in the cooker required for soft packaging, the water legs must be either twice as tall or several legs must be run in series. The cooling zone of the system must also be over-pressurized to maintain the integrity of the package and will also benefit from multiple water legs. Keeping the overall height of a system to a minimum reduces the structural costs for the system, particularly in areas that are prone to high winds or other environmental conditions.

### BRIEF DESCRIPTION OF THE DRAWINGS

A better understanding of the invention can be obtained from the detailed description of exemplary embodiments set forth below, when considered in conjunction with the appended drawings, in which:

FIG. 1 schematically illustrates a continuous system for sterilizing and cooking packaged products;

FIG. 2 schematically illustrates attachment of clips to packages and subsequent cable loading;

FIG. 3 illustrates a single and double leg hydrostatic pressure cooker;

FIG. 4 illustrates an exploded view of a clip for attaching a package to a cable or rail;

FIG. 5 illustrates a side-view of a clip for attaching a package to a cable or rail;

FIG. 6 illustrates a frontal view of a clip for attaching a package to a cable or rail; and

FIG. 7 illustrates a view of an embodiment of a package attached to a cable for conveyance through a sterilizer.

### DETAILED DESCRIPTION

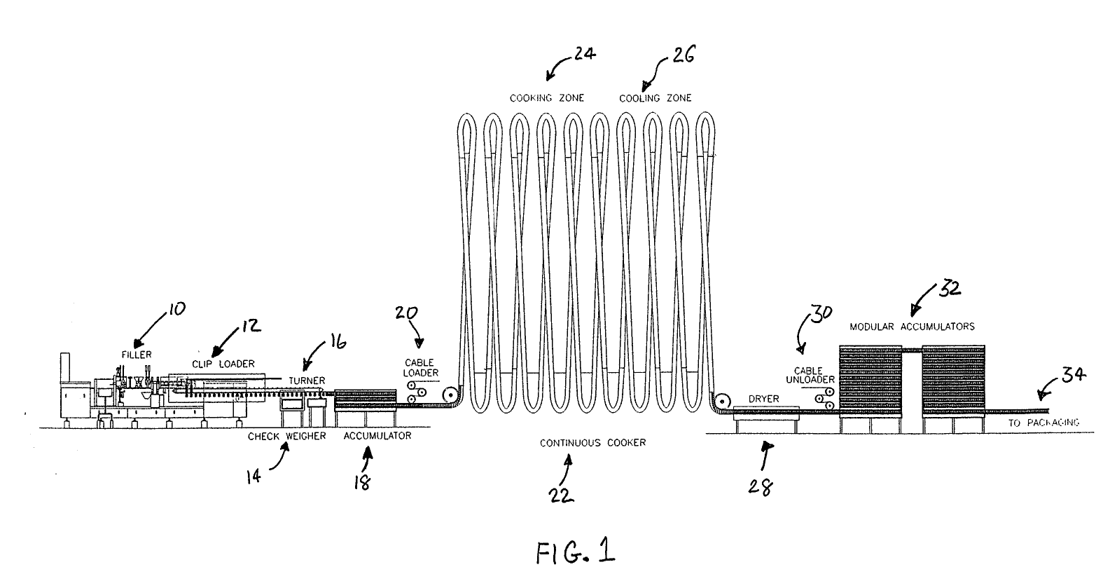

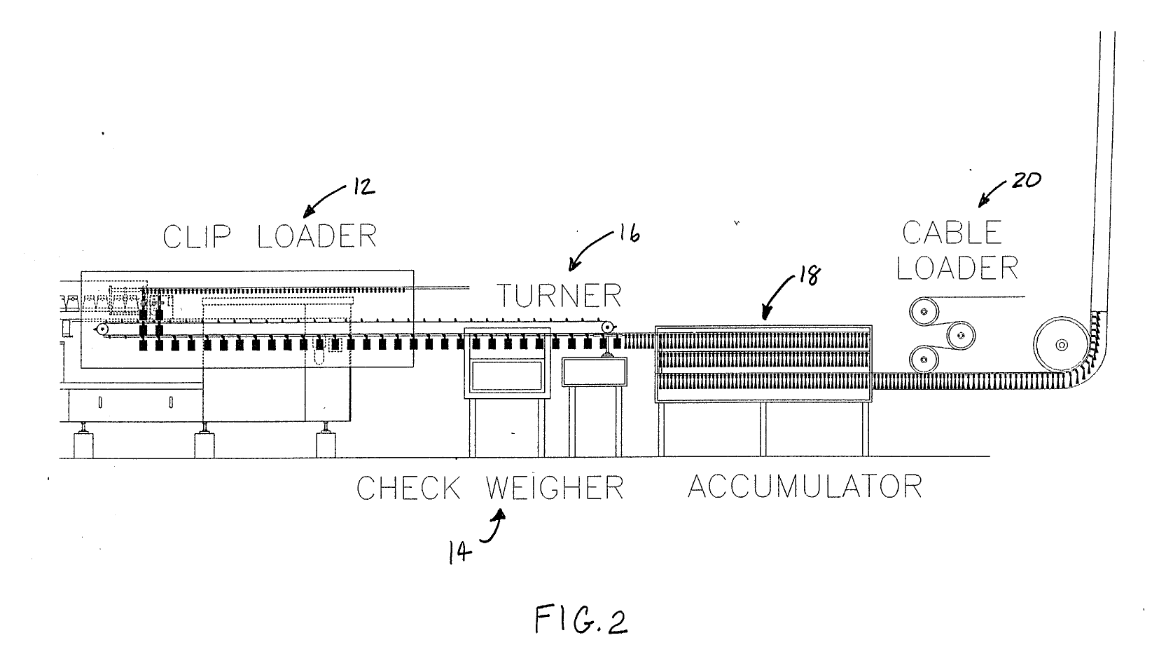

FIG. 1 shows a continuous system for the thermal processing of packaged products. FIG. 2 shows a detailed view from the clip loader 12 to the cable loader 20. A food product is provided at a filler 10 is filled into a package and is preferably sealed. A package cable-attachment device is attached to the filled packaged via a clip loader 12. The package cable-attachment device is capable of clipping to a package for holding and moving the package. The attached package is then moved down the line via a continuous belt through a package check weigher 14. The package check weigher determines a weight for the filled packages.

The package is then turned via a turner assembly 16 and then staged in a package accumulator 18. The package accumulator 18 accumulates or stages packages prior to being transported through the continuous hydrostatic pressure cooker 22. A cable loader 20 will take the packages from the package accumulator 18 and attach the packages to the conveyance cable of the hydrostatic pressure cooker 22. The cable loader 20 can be set to attach packages to the cable at a predetermined distance between packages. The package cable-attachment device has a cable attachment mechanism that is opened to attached to the cable. When the cable attachment mechanism closes, the cable attachment mechanism is secured on the cable.

The packages now secured to the cable of the hydrostatic pressure cooker 22 will be conveyed through the hydrostatic pressure cooker 22 for sterilization and/or cooking. The hydrostatic pressure cooker is adjusted for particular sterilization and cooking needs for the food product being conveyed through the pressure cooker 22. In the illustrated embodiment, the package is conveyed through a cooking zone 24 where the package contents are cooked and the package is sterilized. A pre-heating unit may also be employed to cook the contents of the package prior to conveying the package through the hydrostatic pressure cooker 22. After moving through the cooking zone 24 the package move through a cooling zone 26.

The packages after exiting the hydrostatic pressure cooker 22 are preferably dried using a dryer unit 28. Moisture remaining on the packages is dried. Among various dryer units, a dryer unit with a fan and heating element may be used to blow heated air onto the packages.

The packages then are moved to a cable unloader 30. The cable unloader 30 removes the package cable-attachment device from the cable. The package cable-attachment devices holding the packages are then staged in modular accumulator 32. The accumulated packages are then sent to further packaging 34.

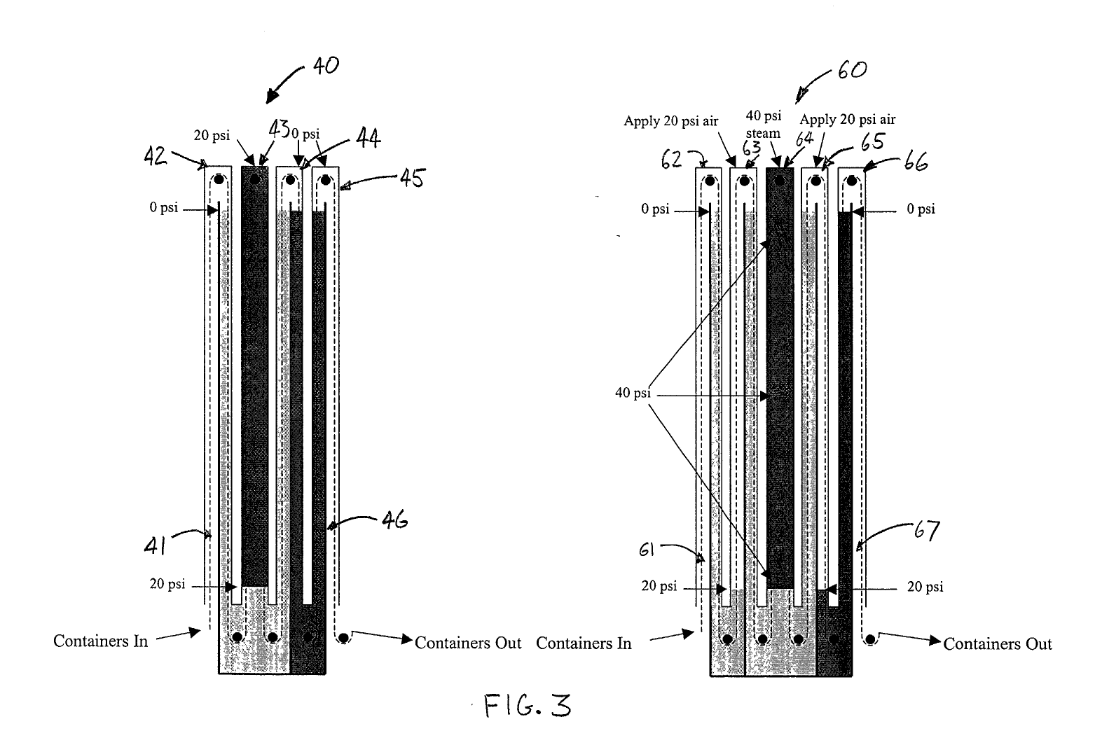

Now referring to FIG. 3, a simplified single water leg 40 and double water leg 60 hydrostatic pressure cooker are shown. Among many usable hydrostatic pressure cooker configurations, two different hydrostatic pressure cookers are shown to illustrate a novel approach to increasing the pressure of a pressure chamber while maintaining or even reducing the height of the towers of the pressure cooker. With the single water leg pressure cooker 40, a single water leg 42 is positioned before the steam chamber 43. The single water leg 42 tower is divided into an atmospheric chamber and a water chamber. Packaged containers are moved into the atmospheric side 41 of the single water leg. The packages attached to the cables, are drawn through the water side of the single water leg 42 tower. The water is preferably heated to begin cooking the packages. The packages are then moved through a pressure chamber 43 where the packages are further cooked and sterilized. After moving through the pressure chamber 43, the packages are moved through a double water chamber tower 44. The double water leg tower 44 has a first chamber having a heated water and a second side having a cooled water. The packages are moved through each side of the double water leg tower. Lastly, the packages pass through a second single water leg tower 45 for further cooling and a second chamber 46 at atmospheric conditions. In the exemplified embodiment, the pressure chamber 43 produces 20 psi.

To increase the pressure of the pressure chamber 64 while maintaining or reducing the height of the towers of the pressure cooker, two single water leg towers 62, 63 may be employed. The first single water leg tower 62 has a first chamber 61 with atmospheric conditions where packages are conveyed into the pressure cooker 60. The second chamber of the tower 62 includes heated water. A second single water leg tower 63 is connected after the first single water leg tower 62. The second single water leg tower 63 has a first chamber with pressurized air. In the embodiment shown, the first chamber has a psi of 20. The second single water leg tower 63 has a second chamber including heated water. Connected to the second water leg tower 63 is a pressurized chamber 64 having pressurized steam. In the embodiment shown the steam is pressurized at 40 psi. A third single water leg tower 65 is connected after the pressure chamber 64. This third single water leg tower 65 has a first chamber with a heated water and a second chamber having pressurized air. In the embodiment shown, the second chamber has a psi of 20. Lastly, in the embodiment shown, a forth single water leg tower 66 is connected after the third single water leg tower 65. This tower 66, has a first chamber with a cooled water and a second chamber 67 at atmospheric conditions.

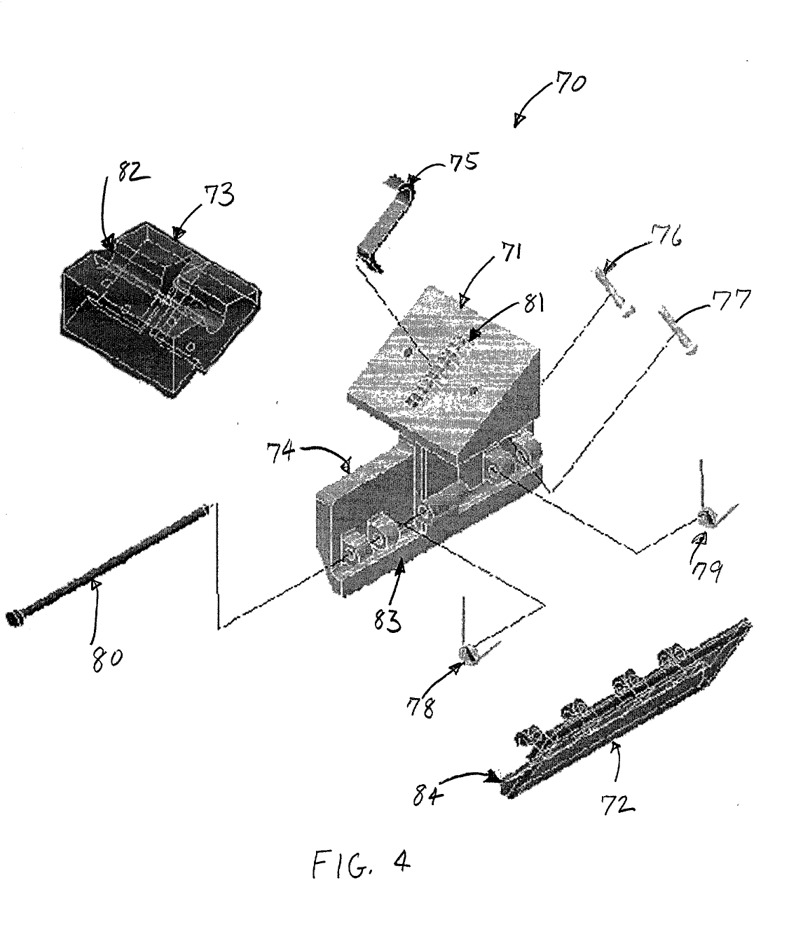

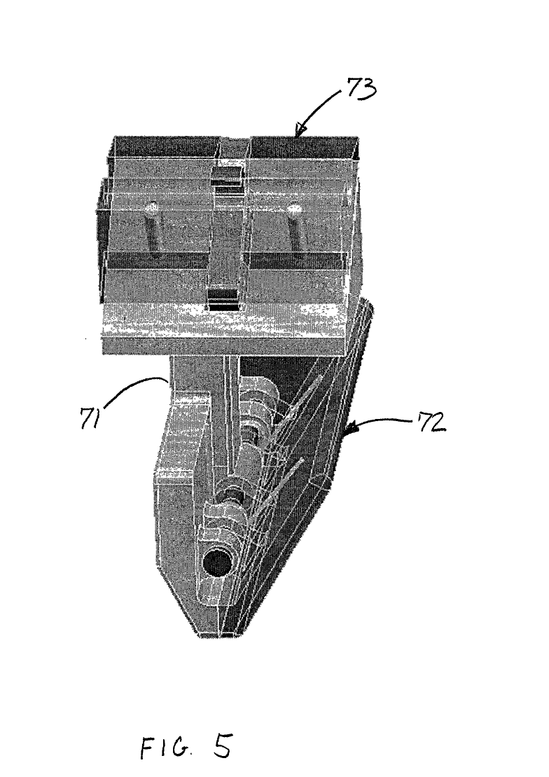

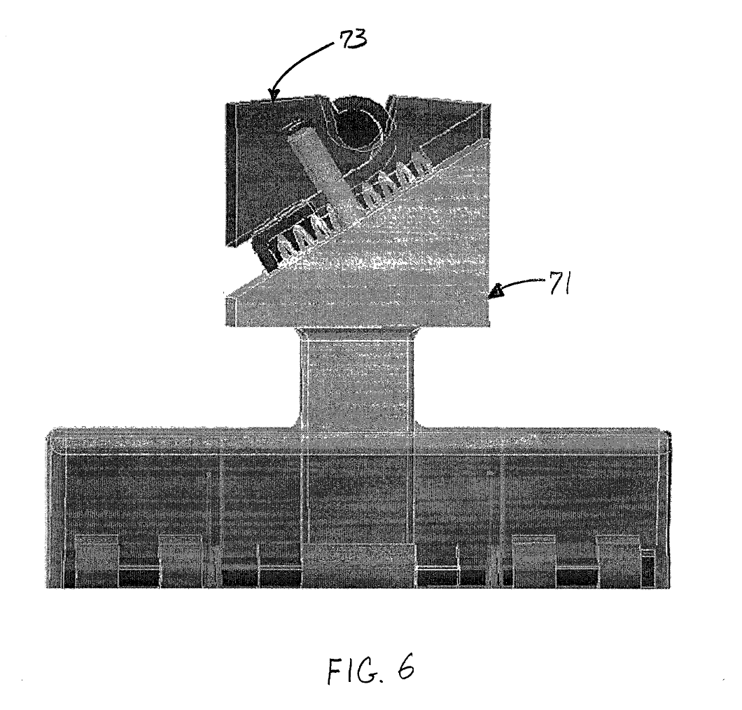

FIGS. 4-6 illustrate various views of a package cable-attachment device preferably utilized with the inventive system. The package cable-attachment device 70 secures a package to a cable for conveyance or transport. The package cable-attachment device 70 has a main body comprised of a rail head 71 and a clip arm 74. A rail cable member 73 is fixed to the rail head 71 by set screws 76 and 77 or other similar attachment method. A cable attachment arm 75 is positioned between the rail cable member 73 and the rail head 71. The cable attachment arm 75 is held in a closed position by a spring 81 set into the rail head 71. The cable member 73 has a channel 82 for positioning a cable onto the cable member 73. The channel 82 is disposed substantially perpendicular to the clip arm 74. The cable member 73 attaches to a cable by sliding open the cable attachment arm 75 and then closing the hooked end of the attachment arm 75 over the cable after the cable is placed into the channel 82.

The clip arm 74 is attached to an arm plate 72 by a pin 80. Spring 78, 79 keep the clip arm 74 and arm plate 72 in a closed position. The package cable-attachment device holds a package between the clip arm 74 and the arm plate 72 at the package attachment surfaces 83, 84. To attach a package to the device 70, the upper surface arm plate is pushed inward toward the clip arm thereby widening the arm plate attachment surface 84 from the clip arm attachment surface 83. When the upper surface is released, the springs 78, 79 cause the arm plate 72 to clamp down on the package, holding the package between the package attachment surfaces 83, 84.

The cable member 73 and the rail head 71 form a rail assembly which can be used to maneuver the package cable-attachment device 70 using a rail or track-type system. Thus, the package cable-attachment device 70 may be conveyed by either a cable or via a rail. For example, a rail system may be employed with the package accumulators 8, 32 (shown in FIG. 1).

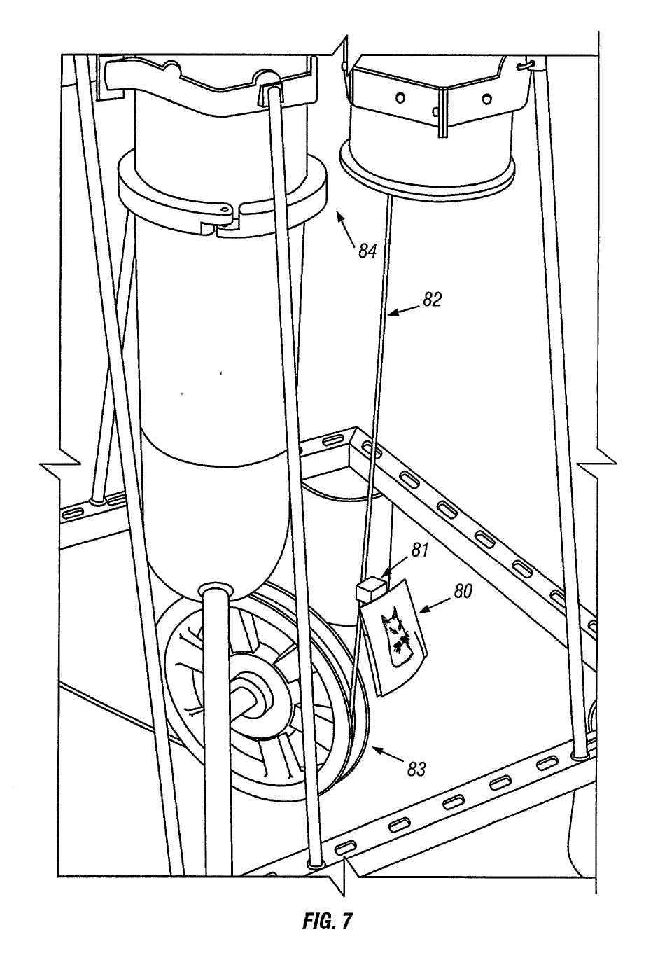

Referring now to FIG. 7, a view of an embodiment of a package clip 81 attached to a package 80 and to a cable 82 is shown. The package 80 is attached to a package clip 81. The package clip 81 is attached to a cable 82. The cable 82 moves through the pressure cooker 84 using a series of pulleys 83 to guide the cable and attached packages through the pressure cooker.

Moreover, the embodiments described are further intended to explain the best modes for practicing the invention, and to enable others skilled in the art to utilize the invention in such, or other, embodiments and with various modifications required by the particular applications or uses of the present invention. It is intended that the appending claims be construed to included alternative embodiments to the extent that it is permitted by the prior art.

What is claimed is:

1. A packaged product sterilization process, said process comprising the steps of:
filling one or more packages with a food product,
attaching said one or more packages to a continuous conveyance mechanism,
moving said continuous conveyance mechanism with attached packages through a sterilizer for sterilization of said packages.

2. The process of claim 1, further comprising sealing said one or more packages to form an air tight seal after filing said one or more packages with said food product.

3. The process of claim 1, wherein the moving step includes moving said one or more packages through said sterilizer to cook said food product contained within the package.

4. The process of claim 1, further comprising the step of before passing said one or more packages through said sterilizer, pre-heating said one or more packages in a heating unit.

5. The process of claim 1, further comprising attaching said one or more package clips to said one or more packages.

6. The process of claim 1, wherein the continuous conveyance mechanism is a moveable cable disposed through said sterilizer.

7. The process of claim 6, wherein the attaching step includes attaching said one or more package clips to said cable.

8. The process of claim 1, further comprising applying heated and pressurized steam to said one or more packages while moving through said sterilizer.

9. The process of claim 8, wherein the pressurized steam is provided at a higher pressure than internal pressure of said one or more packages to prevent rupture of said one or more packages.

10. The process of claim 8, wherein said sterilizer contains chambers of pressurized steam at temperatures and pressures sufficient to cook said food product of said one or more packages.

11. The process of claim 1, further comprising moving said one or more packages through a dryer unit after exiting said sterilizer.

12. The process of claim 1, further comprising exposing said one or more packages to heated steam while in said sterilizer for a time sufficient to provide sterilization of said one or more packages.

13. The process of claim 1, wherein said sterilizer is a hydrostatic pressure cooker.

14. A hydrostatic pressure sterilizer for sterilizing packages, said sterilizer comprising:
a pressurized leg having a pressurized steam chamber;
a first water leg connected before said pressurized leg, said first water leg having an atmospheric chamber and a fluid chamber;
a second water leg connected after said pressurized leg, said second water leg having a fluid chamber and an atmospheric chamber; and
a moveable cable disposed through the first water leg, pressurized leg, and second water leg.

15. The hydrostatic pressure sterilizer of claim 14, wherein the moveable cable is attached to pulleys.

16. The hydrostatic pressure sterilizer of claim 14, further comprising a third water leg connected between said second water leg and said pressurized leg, said third water leg having a first fluid chamber and a second fluid chamber.

17. The hydrostatic pressure sterilizer of claim 14, further comprising:
a third water leg connected between said first water leg and said pressurized leg, said third water leg having a first fluid chamber and an air chamber;
a fourth water leg connected between said pressurized leg and said second water leg, said fourth water leg having a first fluid chamber and an air chamber; and
wherein the air chamber of the third water leg and the air chamber of the fourth water leg have a pressure greater than zero psi.

18. A manufacturing system for sterilizing packages, said system comprising:
a product filler for filling packages with a food product;
a clip loader for attaching package clips to said packages;
a sterilizer having a moveable cable disposed through said sterilizer for moving said packages;
a cable loader for attaching package clips to said moveable cable; and
a cable unloader from removing said package clips from said cable.

19. The manufacturing system of claim 18, further comprising a check weigher for weighing said packages.

20. The manufacturing system of claim 18, further comprising a package dryer for drying packages after exiting said sterilizer.

21. The manufacturing system of claim 18, further comprising a cable unloader unit for removing the packages from the cable.

22. The manufacturing system of claim 18, further comprising an accumulator unit for accumulating packages.

23. An apparatus for conveying a package via a cable or a rail, said apparatus comprising:
a body comprising a rail head and a clip arm,
an arm plate hingedly attached to said clip arm, and
a slideable attachment arm positioned on said rail head.

24. The apparatus of claim 23, wherein the rail head has a channel longitudinally disposed along the rail head.

25. The apparatus of claim 24, wherein the channel is disposed substantially perpendicular to the clip arm.

26. The apparatus of claim 23, wherein the attachment arm is slideably closed by a spring.

27. The apparatus of claim 23, wherein the rail head is shaped for placement in a track.

28. The apparatus of claim 26, wherein the rail head is rectilinearly shaped.
